(19) United States
(12) Patent Application Publication
(10) Pub. No.: US 2021/0247953 A1
(43) Pub. Date: Aug. 12, 2021

(54) System and Method for Manipulating and Transmitting Live Media

(71) Applicant: Daren Karl Brooks, West Haven, UT (US)

(72) Inventor: Daren Karl Brooks, West Haven, UT (US)

(21) Appl. No.: 17/170,465

(22) Filed: Feb. 8, 2021

Related U.S. Application Data
(60) Provisional application No. 62/971,084, filed on Feb. 6, 2020.

(51) Int. Cl. G06F 3/16; H04W 4/21; H04W 4/80; G06F 3/0484; H04L 29/06

(52) U.S. Cl. CPC G06F 3/165; H04W 4/21; H04L 65/60; G06F 3/04842; H04W 4/80

(57) ABSTRACT

A system and method for manipulating and transmitting live media enables a user to collect and manage media inputs, especially audio, and simultaneously broadcast the resulting combination. Software would interface with current technologies to blend the input signals of both live and prerecorded data, or any audio or video data, into one, and then simultaneously broadcast the mixture. This would, in effect, allow the user to sing or speak simultaneously with playing music or any other audio being broadcasted. A short-range wireless network (Bluetooth) compatible cell phone or smartphone can therefore be used for “Karaoke” with any connected Bluetooth media output device or devices. Professionally, presentations of voice with music or other audio or presentation data could be simultaneously broadcast to external speakers or monitors. The device would further be able to alter audio/voice inputs to alter tone, volume, and general quality using readily-available equalizer technology.

The current application claims a priority to the U.S. Provisional Patent application Ser. No. 62/971,084 filed on Feb. 6, 2020. The current application is filed on Feb. 8, 2021 while Feb. 6, 2021 was on a weekend.

### FIELD OF THE INVENTION

The present invention generally relates to media transmission. More specifically, the system and method for manipulating and transmitting live media relates to a method for collecting and combining media, especially audio, from both prerecorded and live sources and subsequently relaying that data to appropriate media output devices.

### BACKGROUND OF THE INVENTION

Current technology allows the wired or wireless broadcast of vocals, songs, or any audio and data to be broadcast or sent through wire or short-range wireless (Bluetooth) connections between devices. This can be done with one device or multiple devices at the same time as well. For example, one Bluetooth-enabled phone can connect to multiple Bluetooth laptops, external speakers, desktop computers, automobile audio systems, headphones and any other system that is equipped with this technology. These connections can be obtained simultaneously or individually depending on the selection of the user. This technology is currently in use with all major transportation manufacturers, including aviation, automobile, marine, motorcycle and more, as well as mobile phone, tablet, laptop computer, desktop computer and audio manufacturers. For example, a song played on a Bluetooth-connected cell phone can be broadcast wirelessly to any of the above-mentioned devices and the music being broadcast will be played through the external speakers, built in speakers, or headphone speakers of the connected device as desired. The same is true of the sending of data.

Using the same Bluetooth technology, a user can speak into the microphone of a cell phone or enabled microphone of any of the other aforementioned devices to collect live audio data and converse with another user, using external devices to relay the signal and complete the conversation. This technology is widely used and needs no more explanation.

What has been lacking in the industry is the ability to combine the voice of the user with the broadcast of multiple other signals from a mobile device. Such technology could further enable a user to capture and manipulate video data as well. Further lacking is the ability to adjust balance, volume, equalization, leveling, and other such tunable audio features of audio signals while broadcasting. This new mobile application would provide that capability, specifically the capability to mix and then broadcast this mix of multiple signals and inputs simultaneously that is not currently available in the marketplace.

The present invention addresses these issues. The present invention enables a user to collect and manage audio inputs but would also gain the new ability of simultaneously broadcasting. Software would interface with current technologies to blend the input signals of both live and prerecorded data, or any audio or video data, into one, and then simultaneously broadcasting the mixture. This would, in effect, allow the user to sing or speak simultaneously with the playing music or any other audio being broadcasted. A Bluetooth-enabled cell phone or smartphone can be used for “Karaoke” with any connected Bluetooth device or devices. Professionally, this could be used for presentations of voice to external speakers with music or other audio or presentation data simultaneously being broadcast. After installation of the application, the device would be able to adjust the level volume inputs of both live vocals as well as of music or other audio data. The device would further be able to alter audio/voice inputs to enhance or alter tone and quality using readily-available equalizer technology to manipulate bass, mid-range, and treble segments of the audio output. In addition, the device could record the mixture of voice/audio/video inputs and allow playback or broadcast of the mixed recording. This application would be available in both iOS and Android formats.

The application would use existing external microphone voice inputs, including, but not limited to, wired microphones from headphones, headsets, or other current microphone inputs. Multiple users would allow for combined live audio from multiple sources, which each could be broadcast to output devices shared through Bluetooth connections. The application would also utilize existing speakers, as well as video recording, audio recording, Bluetooth sharing, and microphone software functions that are all currently available on most mobile and all of the aforementioned external devices. After completion of recording and/or live broadcasting, the application would allow posting of recordings, including audio, video and mixtures of both to any current social media sites.

### BRIEF DESCRIPTION OF THE DRAWINGS

FIG. 1 is a block diagram illustrating the system of the present invention.

FIG. 2 is a flowchart illustrating the overall process of the present invention.

FIG. 3 is a continuation of FIG. 2.

FIG. 4 is a flowchart illustrating a subprocess of utilizing a video camera to capture live video content.

FIG. 5 is a flowchart illustrating a subprocess of collecting external video content.

FIG. 6 is a flowchart illustrating a subprocess of editing video content.

FIG. 7 is a flowchart illustrating a subprocess of connecting to multiple output devices.

FIG. 8 is a flowchart illustrating a subprocess of adjusting live audio output settings.

FIG. 9 is a flowchart illustrating a subprocess of adjusting prerecorded audio output settings.

FIG. 10 is a flowchart illustrating a subprocess of sharing content on social media networks.

### DETAILED DESCRIPTION OF THE INVENTION

All illustrations of the drawings are for the purpose of describing selected versions of the present invention and are not intended to limit the scope of the present invention.

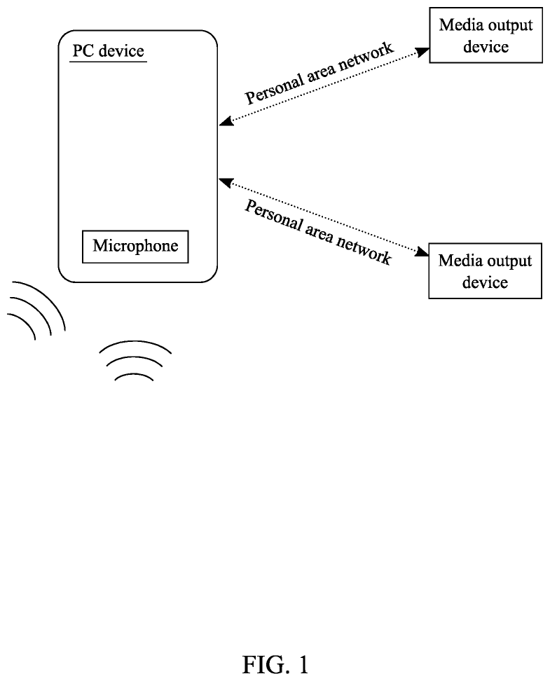

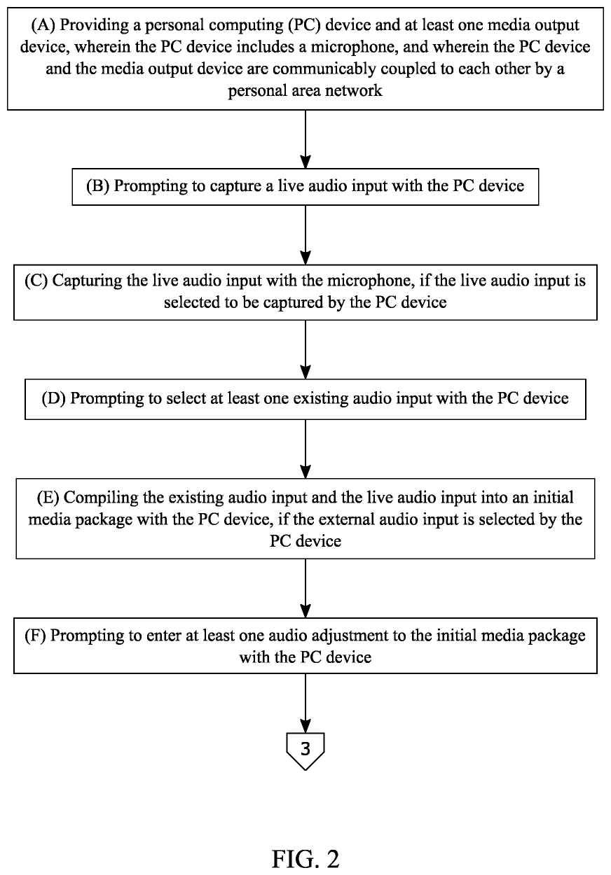

The present invention is a system and method for manipulating and transmitting live media that allows a user to collect and combine media, especially audio, from both prerecorded and live sources and subsequently relay that data to appropriate media output devices, as represented in FIG. 1. The present invention further enables a user to manipulate and manage media prior to or simultaneously during broadcasting. The system of the present invention may include a personal computing (PC) device and at least one media device, wherein the PC device includes a microphone, and wherein the PC device and the media output device are communicably coupled to each other by a personal area network (Step A), as represented in FIG. 2. The PC device relates to any of smartphones, tablets, laptop computers, desktop computers, smart devices, or any other device capable of sustaining a short-range wireless connection. The at least one media device is any of speakers, monitors, integrated and nonintegrated sound systems, or other appropriate devices capable of projecting, amplifying, or otherwise translating and communicating data from the PC device. The microphone is an audio sensor capable of collecting sound waves and converting collected waves into electronic signals for subsequent interpretation by the PC device. The personal area network relates to any short-range wireless network capable of supporting live streaming of media.

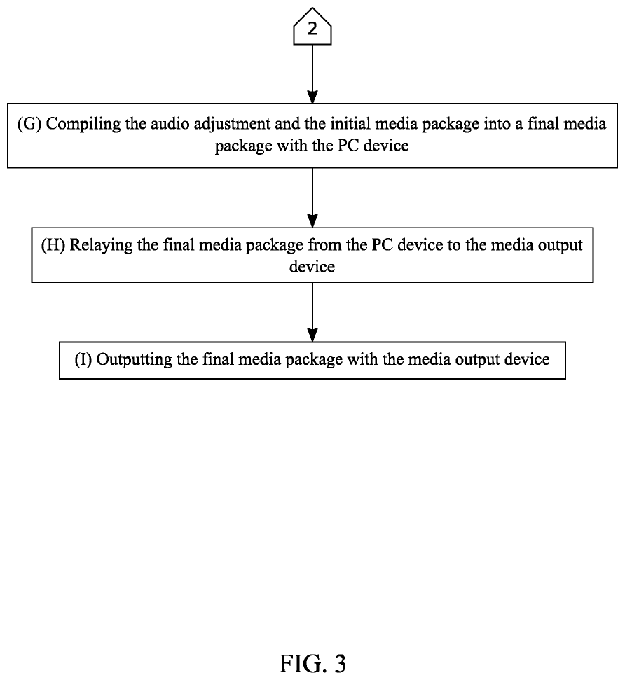

The overall process followed by the method of the present invention allows for effective and efficient management and broadcasting of media data. A live audio input is prompted to be captured with the PC device (Step B). Thus, a user may choose to speak or create words and sounds for subsequent mixing, broadcasting, and/or recording. In a preferred embodiment, the live audio input pertains to human vocals, such as sung or recited lyrics; however, it is to be understood by a professional in the field of the present invention that other sounds, including spoken words, instrumental noises, sound effects, and more may also be acceptable as the live audio input, and the preferred embodiment is not meant to be limiting. The live audio input is then captured with the microphone, if the live audio input is selected to be captured by the PC device (Step C). In this way, the microphone may capture audio data and relay appropriate electronic signals to the PC device. Next, at least one existing audio input is prompted to be selected with the PC device (Step D). This arrangement enables a user to broadcast existing media, such as prerecorded songs, sounds, noises, and more, to the at least one media device, often in conjunction with the live audio input. Such media may be gathered from a variety of sources, including, but not limited to, personally recorded voice audio upon the PC device and streaming audio from various web services such as Spotify or Pandora. The existing audio input and the live audio input are compiled into an initial media package with the PC device, if the external audio input is selected by the PC device (Step E). The initial media package is a combined media file containing all relevant audio data necessary for broadcasting. At least one audio adjustment is then prompted to be entered to the initial media package with the PC device (Step F). The at least one audio adjustment may relate to any of a variety of potential audio manipulation techniques, including pitch, volume, tone, fade, reverb, loops, and other manipulations, thereby offering a user multifaceted control over the final audio product. The audio adjustment and the initial media package are then compiled into a final media package with the PC device (Step G), as represented in FIG. 3. Thus, the basic audio data plus the desired manipulations are prepared for transmission to appropriate output devices. The final media package is next relayed from the PC device to the media output device (Step H). In this way, the final media package is prepared and accessible for use by the media output device or devices. Finally, the final media package is outputted with the media output device (Step I). Thus, the media output device may present the desired media content to an appropriate audience, due to selection of the media output device or devices being at the discretion of the user.

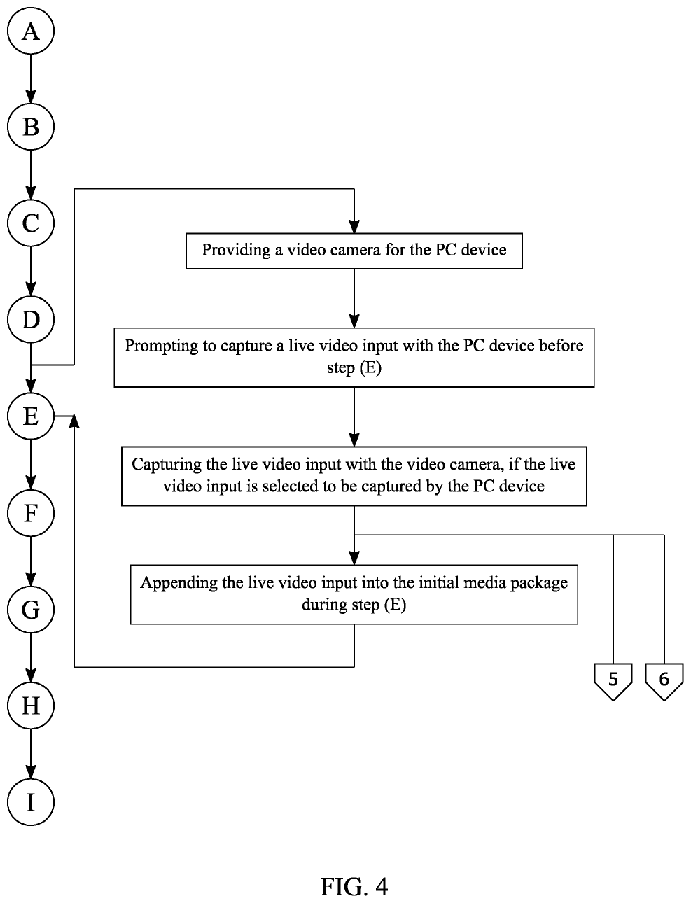

The present invention requires a method and associated systems by which to obtain video data. To achieve this, a video camera may be provided for the PC device, as represented in FIG. 4. The video camera relates to any of a variety of image capturing devices capable of converting visual light into electronic signals. The video camera may be among, but not limited to, freestanding cameras, subsystem cameras commonly found upon mobile devices, integrated video cameras as in cars, motorcycles, airplanes, and other vehicles, and more. A live video input is prompted to be captured with the PC device before Step E. The live video input relates to ambient visual data that may be captured live by a user. The live video input is then captured with the video camera, if the live video input is selected to be captured by the PC device. Thus, a user may collect video data for subsequent media manipulation and broadcasting to appropriate devices. Next, the live video input is appended into the initial media package during Step E. Thus, live video content may be primed for manipulation and broadcasting along with relevant audio data.

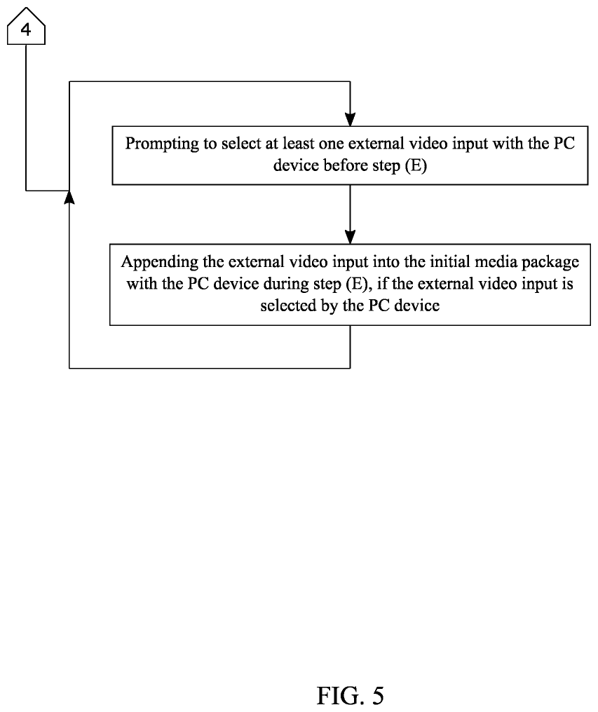

It may be further desirable to utilize existing video content with live or prerecorded audio content. To this end, at least one external video input is prompted to be selected with the PC device before Step E, as represented in FIG. 5. The at least one external video input denotes any prerecorded videos or visual content that a user may wish to present alongside audio in the initial media package. The at least one external video input may include private video content, including video previously recorded by the user, or public video content, such as that provided by any of a variety of content streaming web sites and services. The external video input is then appended into the initial media package with the PC device during Step E, if the external video input is selected by the PC device. In this way, the external video content may be adjusted and combined with audio content in order to create a full multimedia presentation.

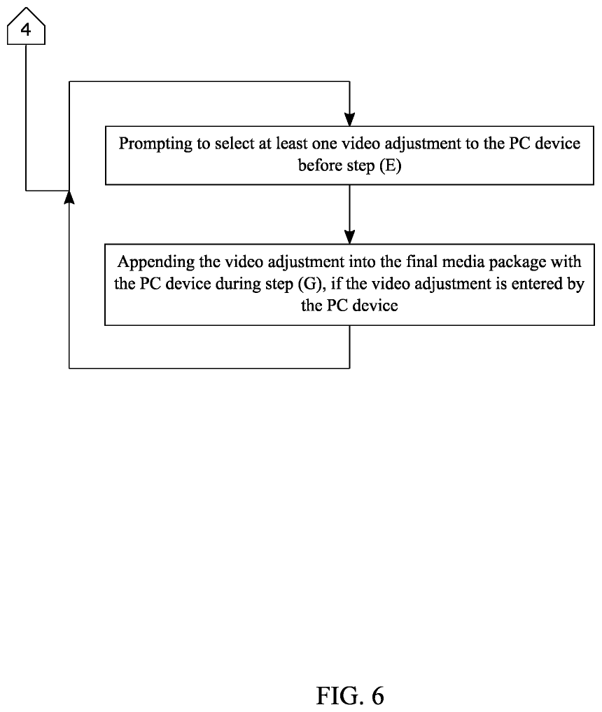

A user may further desire to manipulate video content before broadcasting such content. To enable this, at least one video adjustment may be prompted to be entered to the initial media package with the PC device after Step E, as represented in FIG. 6. The at least one video adjustment may include visual data manipulation techniques including any or all of filters, zoom, focus, depth of field, content addition, distortion, and more. The video adjustment is then appended into the final media package with the PC device during Step G, if the video adjustment is entered by the PC device. This arrangement enables a user to control and modify all content before broadcasting or otherwise outputting that content.

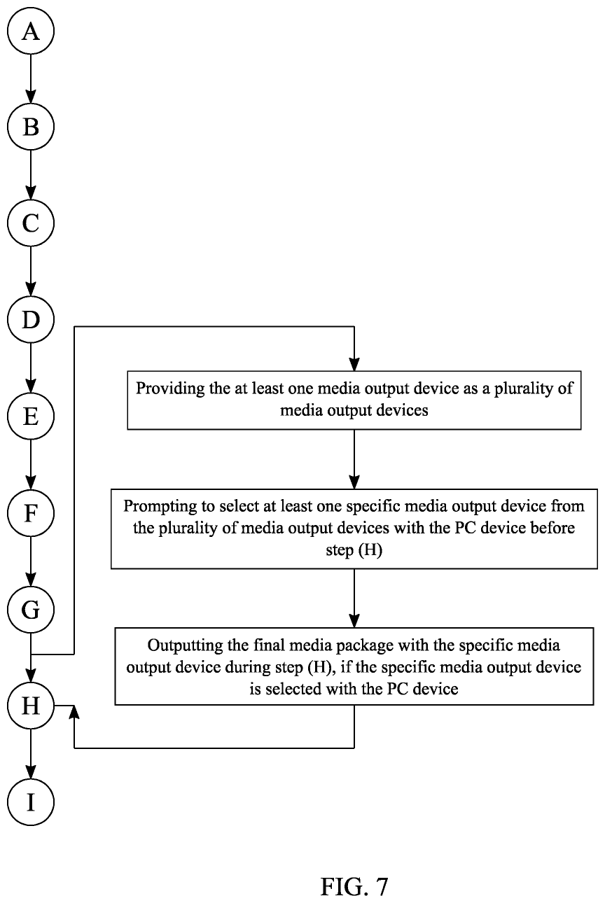

A user of the present invention may wish to connect to many devices simultaneously for presentation purposes. To this end, the at least one media output device may be provided as a plurality of media output devices, as represented in FIG. 7. Such a distinction may be notable during use of the present invention as, for example, a microphone at a large conference, in which a presenter may need to connect to multiple electronic speakers in order to effectively direct audio or media towards a large crowd. At least one specific media output device is next prompted to be selected from the plurality of media output devices with the PC device before Step H. The at least one media device is preferably selected from a list of all available short-range wireless connection-enabled devices, thus allowing a user to determine which specific speakers, monitors, and other devices to broadcast to. Finally, the final media package is outputted with the specific media output device during Step H, if the specific media output device is selected with the PC device. In this way, appropriate devices may be utilized to share audio or multimedia data as relevant.

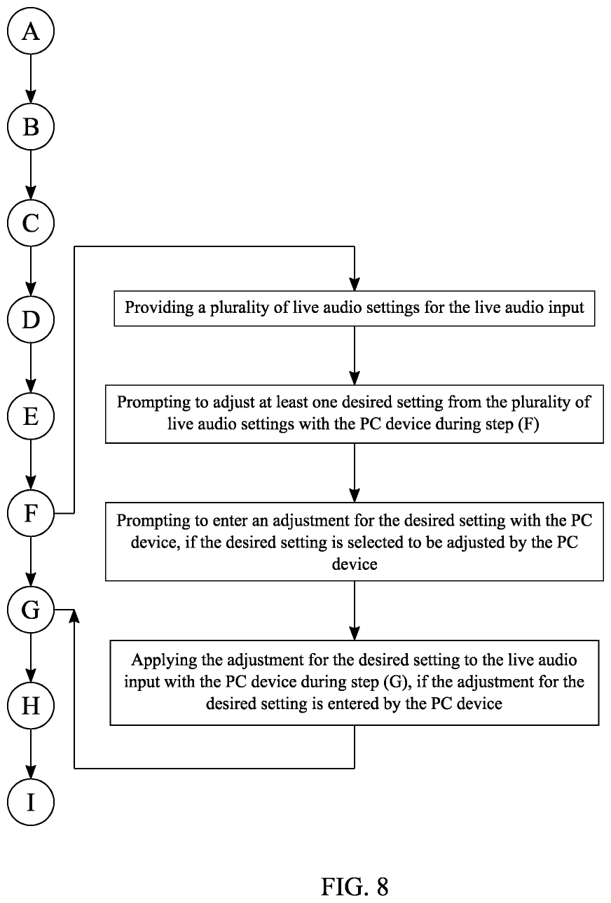

There are a variety of audio tools and settings that may be adjusted in order to enable a user to achieve an optimal audio output in relation to audio recorded in real-time. To this end, a plurality of live audio settings may be provided for the live audio input, as represented in FIG. 8. The plurality of live audio settings may include a variety of potentially useful tools, including balancers, faders, equalizers, loopers, volume controls, and more. At least one desired setting from the plurality of live audio settings is prompted to be adjusted with the PC device during Step F. This enables a user to adjust live audio settings one at a time. An adjustment for the desired setting is then prompted to be entered with the PC device, if the desired setting is selected to be adjusted by the PC device. The adjustment for the desired setting may be communicated through use of a corresponding representational interface component presented upon the PC device, such as a dial, switch, button, lever, slider, or other such visual representations of useful live audio manipulation tools. Finally, the adjustment for the desired setting is applied to the live audio input with the PC device during Step G, if the adjustment for the desired setting is entered by the PC device. In this way, a user may apply precise manipulations and adjustments to live audio content prior to or during broadcasting.

It may be common for a user of the present invention to need to adjust the volume of live audio before or during presentation or broadcasting. To enable this, the plurality of live audio settings may include a volume setting. The volume setting may have a more convenient or accessible interface when compared to the other settings of the plurality of live audio settings.

Similarly, it may be common for a user of the present invention to need to adjust the balance of live audio across low, mid-range, or high frequencies before or during presentation or broadcasting. To enable this, the plurality of live audio settings may include at least one equalizer setting. The equalizer setting may have a more convenient or accessible interface when compared to the other settings of the plurality of live audio settings.

It may further be desirable for a user of the present invention to enable automatic adjustment of live audio settings. To provide for this, the plurality of live audio settings may include at least one automated tonal correction setting. The automated tonal correction setting will enable a user to potentially perform or generate more pleasant audio output with respect to common tonal patterns, background music or sounds, or more.

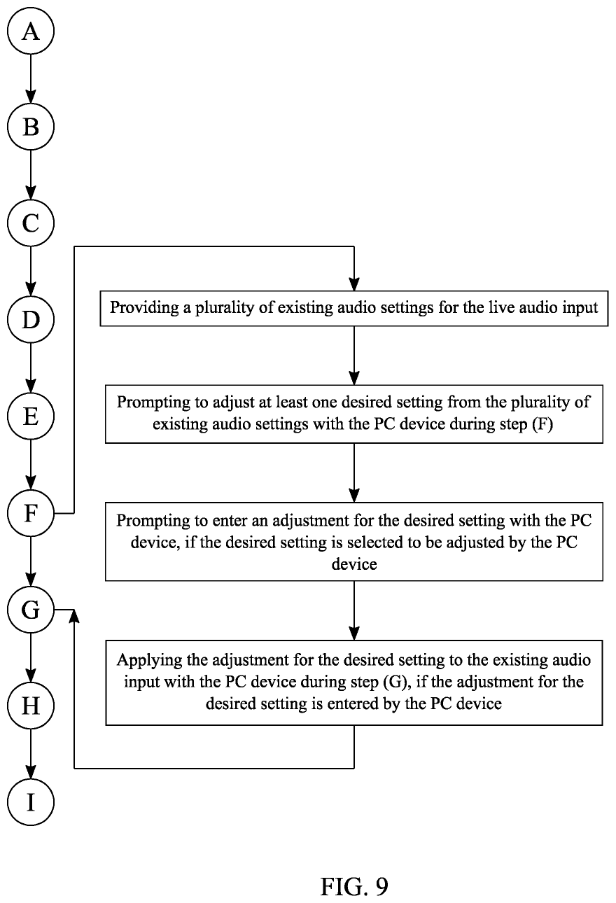

There are a variety of audio adjustments and settings that may be modified in order to enable a user to achieve an optimal audio output in relation to prerecorded audio. To this end, a plurality of existing audio settings may be provided for the existing audio input, as represented in FIG. 9. The plurality of existing audio settings may include a variety of potentially useful tools, including balancers, faders, equalizers, loopers, volume controls, and more. At least one desired setting from the plurality of existing audio settings is prompted to be adjusted with the PC device during Step F. This enables a user to adjust existing audio settings one at a time. An adjustment for the desired setting is then prompted to be entered with the PC device, if the desired setting is selected to be adjusted by the PC device. The adjustment for the desired setting may be communicated through use of a corresponding representational interface component presented upon the PC device, such as a dial, switch, button, lever, slider, or other such visual representations of useful existing audio manipulation tools. Finally, the adjustment for the desired setting is applied to the existing audio input with the PC device during Step G, if the adjustment for the desired setting is entered by the PC device. In this way, a user may apply precise manipulations and adjustments to existing audio content prior to or during broadcasting.

It may be common for a user of the present invention to need to adjust the volume of existing audio before or during presentation or broadcasting. To enable this, the plurality of existing audio settings may include a volume setting. The volume setting may have a more convenient or accessible interface when compared to the other settings of the plurality of existing audio settings.

Similarly, it may be common for a user of the present invention to need to adjust the balance of existing audio across low, mid-range, or high frequencies before or during presentation or broadcasting. To enable this, the plurality of existing audio settings may include at least one equalizer setting. The equalizer setting may have a more convenient or accessible interface when compared to the other settings of the plurality of existing audio settings.

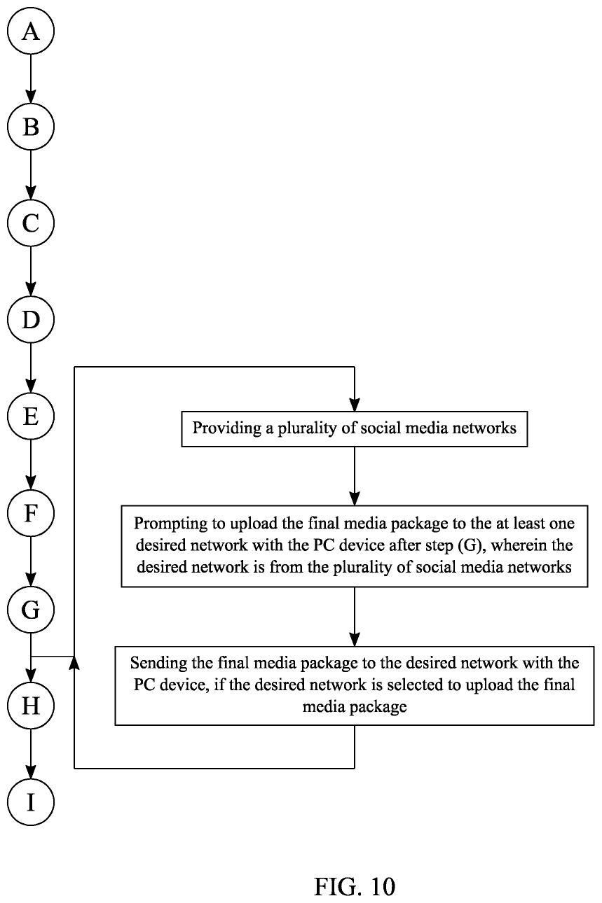

Upon completion of the final media package, a user may wish for the ability to post created and edited content online, in addition to broadcasting live. To enable this, a plurality of social media networks may be provided, as represented in FIG. 10. The plurality of social media networks relates to a set of websites, services, applications, or other software packages, such as Facebook, Instagram, Twitter, and more, which allow for public sharing of audio or multimedia content. The final media package is next prompted to upload to at least one desired network with the PC device after Step G, wherein the desired network is from the plurality of social media networks. In this way, a user may select a desired posting destination or destinations before sharing the final media package. Finally, the final media package is sent to the desired network with the PC device, if the desired network is selected to upload the final media package. Thus, the user may share the final media package with a desired audience online using existing social media technologies.

Although the invention has been explained in relation to its preferred embodiment, it is to be understood that many other possible modifications and variations can be made without departing from the spirit and scope of the invention as hereinafter claimed.

What is claimed is:

1. A method for manipulating and transmitting live media, the method comprises the steps of:
(A) providing a personal computing (PC) device and at least one media output device, wherein the PC device includes a microphone, and wherein the PC device and the media output device are communicably coupled to each other by a personal area network;
(B) prompting to capture a live audio input with the PC device;
(C) capturing the live audio input with the microphone, if the live audio input is selected to be captured by the PC device;
(D) prompting to select at least one existing audio input with the PC device;
(E) compiling the existing audio input and the live audio input into an initial media package with the PC device, if the external audio input is selected by the PC device;
(F) prompting to enter at least one audio adjustment to the initial media package with the PC device;
(G) compiling the audio adjustment and the initial media package into a final media package with the PC device;
(H) relaying the final media package from the PC device to the media output device; and
(I) outputting the final media package with the media output device.

2. The method for manipulating and transmitting live media, the method as claimed in claim 1 comprises the steps of:
providing a video camera for the PC device;
prompting to capture a live video input with the PC device before step (E);
capturing the live video input with the video camera, if the live video input is selected to be captured by the PC device; and
appending the live video input into the initial media package during step (E).

3. The method for manipulating and transmitting live media, the method as claimed in claim 2 comprises the steps of:
prompting to select at least one external video input with the PC device before step (E); and
appending the external video input into the initial media package with the PC device during step (E), if the external video input is selected by the PC device.

4. The method for manipulating and transmitting live media, the method as claimed in claim 2 comprises the steps of:
prompting to enter at least one video adjustment to the initial media package with the PC device after step (E); and
appending the video adjustment into the final media package with the PC device during step (G), if the video adjustment is entered by the PC device.

5. The method for manipulating and transmitting live media, the method as claimed in claim 1 comprises the steps of:
providing the at least one media output device as a plurality of media output devices;
prompting to select at least one specific media output device from the plurality of media output devices with the PC device before step (H); and
outputting the final media package with the specific media output device during step (H), if the specific media output device is selected with the PC device.

6. The method for manipulating and transmitting live media, the method as claimed in claim 1 comprises the steps of:
providing a plurality of live audio settings for the live audio input;
prompting to adjust at least one desired setting from the plurality of live audio settings with the PC device during step (F);
prompting to enter an adjustment for the desired setting with the PC device, if the desired setting is selected to be adjusted by the PC device; and
applying the adjustment for the desired setting to the live audio input with the PC device during step (G), if the adjustment for the desired setting is entered by the PC device.

7. The method for manipulating and transmitting live media, the method as claimed in claim 6 wherein the plurality of live audio settings includes a volume setting.

8. The method for manipulating and transmitting live media, the method as claimed in claim 6 wherein the plurality of live audio settings includes at least one equalizer setting.

9. The method for manipulating and transmitting live media, the method as claimed in claim 6 wherein the plurality of live audio settings includes at least one automated tonal correction setting.

10. The method for manipulating and transmitting live media, the method as claimed in claim 1 comprises the steps of:
providing a plurality of existing audio settings for the existing audio input;
prompting to adjust at least one desired setting from the plurality of existing audio settings with the PC device during step (F);
prompting to enter an adjustment for the desired setting with the PC device, if the desired setting is selected to be adjusted by the PC device; and
applying the adjustment for the desired setting to the existing audio input with the PC device during step (G), if the adjustment for the desired setting is entered by the PC device.

11. The method for manipulating and transmitting live media, the method as claimed in claim 10 wherein the plurality of existing audio settings includes a volume setting.

12. The method for manipulating and transmitting live media, the method as claimed in claim 10 wherein the plurality of existing audio settings includes at least one equalizer setting.

13. The method for manipulating and transmitting live media, the method as claimed in claim 1 comprises the steps of:
providing a plurality of social media networks;
prompting to upload the final media package to at least one desired network with the PC device after step (G), wherein the desired network is from the plurality of social media networks; and
sending the final media package to the desired network with the PC device, if the desired network is selected to upload the final media package.
